(19) United States
(12) Patent Application Publication
(10) Pub. No.: US 2019/0346921 A1
(43) Pub. Date: Nov. 14, 2019

(54) DEVICES HAVING SYSTEM WITH ENHANCED FUNCTIONALITY FOR REDUCING THE IMPACT OF NEAR DISTANCE VIEWING ON MYOPIA ONSET AND/OR MYOPIA PROGRESSION

(71) Applicant: Johnson & Johnson Vision Care, Inc., Jacksonville, FL (US)

(72) Inventors: Vicente Caride, New York, NY (US); Orion Fields, Raritan, NJ (US); Alexandra Kramer, New York, NY (US); Ross Moody, Raritan, NJ (US); Noah Nethery, Raritan, NJ (US); Ernesto Quinteros, New Brunswick, NJ (US); Daniel Sarnelli, Raritan, NJ (US); Ryan Schnaufer, Raritan, NJ (US); Urmil Shah, Raritan, NJ (US)

(21) Appl. No.: 16/521,918

(22) Filed: Jul. 25, 2019

Related U.S. Application Data
(63) Continuation-in-part of application No. 15/926,344, filed on Mar. 20, 2018.

(51) Int. Cl. G06F 3/01; G02C 7/06; G02B 27/01

(52) U.S. Cl. CPC G06F 3/013; G08B 21/182; G02B 27/0179; G02C 7/06

(57) ABSTRACT

The present invention is directed to a system that may be incorporated into currently available electronic devices such as laptops, cell-phones and tablets, that help the user to maintain a viewing distance that is safe for the eyes. In order to avoid near-point stress on the eyes which may lead to the onset of myopia and/or accelerate the progression of myopia, especially in children or young adults, the system of the present invention monitors viewing distance and automatically distorts the image and/or text display into a format that is unreadable, for example, through blurring or pixilation, when the device is too close to the viewer. Alternatively, the system may automatically turn off the display when the device is too close and turn the display on when the device is at the proper viewing distance.

### CROSS REFERENCE TO RELATED APPLICATION

This patent application is a continuation-in-part of U.S. patent application Ser. No. 15/926,344, filed Mar. 20, 2018.

### BACKGROUND OF THE INVENTION

### 1. Field of the Invention

The present invention relates to two-dimensional electronic displays, and more particularly, to two-dimensional electronic displays incorporating a combination of hardware and software for establishing safer viewing distances to reduce the incidence of near-point stress and thereby reduce the onset of myopia and/or reduce the likelihood of myopia progression caused thereby.

### 2. Discussion of the Related Art

Myopia or nearsightedness is an optical or refractive defect of the eye wherein rays of light from an image focus to a point before they reach the retina. Myopia generally occurs because the axial length of the eyeball globe is too long or the anterior surface of the cornea is too steep. Myopia affects up to thirty-three (33) percent of the population of the United States and in some parts of the world, up to seventy-five percent of the population. The cause of this refractive error is not specifically known; however, it is most likely due to a combination of genetic factors, for example, eye globe size and corneal curvature, and environmental factors, including adaptive environmental stress. A minus powered spherical lens may be utilized to correct myopia. The minus powered lens diverges the incoming light rays thereby moving the focal point of the image back onto the macula. As set forth herein, these corrective lenses treat myopia, but do not prevent the progression of myopia.

Myopia progression is fueling dramatic increases in the condition. As an example, sixty years ago, approximately fifteen (15) percent of the Chinese population was nearsighted. That percentage today is close to 90 percent for teenagers and young adults. And while this is reaching epidemic proportions in Asia, increases are also taking place in Europe and the United States where approximately half of young adults are likely near sighted.

A number of methods to slow or retard myopia progression, especially in children, have been proposed and developed. These methods including utilizing multi-focal lenses, utilizing lenses with one or more aberrations introduced therein, utilizing lenses which control aberrations, utilizing off axis power lenses, reshaping the cornea, exercising the eye and utilizing pharmacological or drug therapies. Specifically, atropine, a non-selective muscarinic agent, has been shown in a number of studies to be useful in the treatment of myopia.

The use of multi-focal lenses and those having aberrations have proved to be somewhat disadvantageous in that the lenses may compromise the wearer's distance vision and have limited treatment efficacy of around thirty (30) percent to fifty (50) percent of axial elongation or refractive difference to age matched control group as shown in a number of published studies. The other methods set forth above also suffer from disadvantages, including discomfort, as with the corneal reshaping, and potentially undesirable side effects, as with the pharmacological or drug therapies.

The above described solutions focus on devices and/or therapeutic agents that directly impact the eyes of an individual without addressing external environmental concerns that may impact myopia onset and/or progression. One such environmental concern is the accommodative stress from viewing images produced by electronic displays too closely. Accordingly, there exists a need for a system for automatically establishing safer viewing distances of electronic displays to avoid near-point stress.

### SUMMARY OF THE INVENTION

The displays having a system for reducing the impact of near distance viewing on myopia onset and/or myopia progression of the present invention overcomes a number of disadvantages associated with the current state of the art.

In accordance with one aspect, the present invention is directed to a system for reducing the impact of near distance viewing on at least one of myopia onset and myopia progression. The system comprising an electronic display, a range finder operatively associated with the electronic display and configured to determine the distance between a user and the electronic display, a display controller operatively associated with the electronic display, and a microprocessor in communication with and configured to coordinate the operation of the range finder and the display controller, wherein the microprocessor is configured to automatically disrupt the display via the display controller when the display is too close to the user and automatically restoring the image when the display is at a proper viewing distance, the microprocessor including an application having calibration and disruption event functionality to determine interpupillary distance and distance from the user to the display, wherein if the display is less than fifteen inches from the user then the display is disrupted and if the display is greater than fifteen inches from the user then the image is not disrupted.

In accordance with another aspect, the present invention is directed to a method for reducing the impact of near distance viewing on at least one of myopia onset and myopia progression. The method comprising the steps of implementing an application on a device, the application calculating the interpupillary distance between a user's eyes and the distance between a user and an electronic display, the application continuously running while the device is on, automatically disrupting an image displayed on the electronic display when the calculated distance between a user and the electronic display is below a predetermined threshold, and automatically restoring the image displayed on the electronic display when the calculated distance between a user and the electronic display is at or above the predetermined threshold.

One of the risk factors for myopia development and myopia progression is near work. Due to accommodative lag or negative spherical aberration associated with accommodation during such near work, the eyes may experience hyperopic blur, which in turn stimulates myopia progression. Hyperopic blur or defocus is known to lead to predictable, in terms of both direction and magnitude, changes in eye growth, consistent with the eyes growing to compensate for the imposed defocus. Hyperopic blur results in the thinning of the choroid and an increase in the scleral growth rate which results in myopic refractive errors. Moreover, the accommodation system is an active adaptive optical system which is impacted by optical devices as well as the working distance. The present invention is simple and easy to implement solution to near-point eye stress which in turn preferably reduces the incidence of and/or progression of myopia.

The present invention is directed to a system that may be incorporated into currently available electronic devices such as laptops, desktop computers, cell-phones and tablets, that help the user to maintain a viewing distance that is safe for the eyes. In order to avoid near-point stress on the eyes which may lead to the onset of myopia and/or accelerate the progression of myopia, especially in children or young adults, the system of the present invention monitors viewing distance and automatically distorts the image and/or text display into a format that is unreadable, for example, through blurring or pixilation, when the device is too close to the viewer. Alternatively, the system may automatically turn off the display when the device is too close and turn the display on when the device is at the proper viewing distance.

### BRIEF DESCRIPTION OF THE DRAWINGS

The foregoing and other features and advantages of the invention will be apparent from the following, more particular description of preferred embodiments of the invention, as illustrated in the accompanying drawings.

FIG. 1 is a block diagram representation of an exemplary system for reducing the impact of near point viewing in accordance with the present invention.

FIG. 2 is a diagrammatic representation of a user viewing an electronic device with display in accordance with the present invention.

FIGS. 3A and 3B are diagrammatic illustrations of an electronic device utilized too closely and an electronic device utilized at the proper viewing distance respectively in accordance with the present invention.

FIGS. 4A and 4B are diagrammatic representations of an adult's face and a child's face respectively mapped in accordance with the present invention.

FIG. 5 is flow chart of an application for enhanced disruption of viewing in accordance with the present invention.

### DETAILED DESCRIPTION OF THE PREFERRED EMBODIMENTS

The present invention is directed to a system that enables a user to view two-dimensional electronic displays from a distance that minimizes the effects of chronic near-point stress on the muscles of the eye. Asthenopia is the technical term for a weakness or fatigue of the eye and it may be classified as accommodative asthenopia which arises from a strain of the ciliary muscle or muscular asthenopia which arises from a strain of the extra-ocular muscles. Both forms may result from reading or concentrating on images presented on a two-dimensional display too closely. Minimizing the effects of near-point eye stress is important because near-point eye stress may have a negative impact on eye health, particularly in children and young adults. Refractive status is influenced by vision development, adaptation to environmental stress and hereditary factors such as eye globe size and shape. Accordingly, repeated near-point eye stress may impact a child's or young adult's refractive development as they are more susceptible to environmental factors during development. Near-point eye stress may also adversely impact an adult's refractive development even though an adult's vision is more stable. In other words, repeated or chronic near-point eye stress may make a child and or a young adult myopic and/or accelerate the progression of myopia, and to a lesser extent the same result may be found in adults.

Near-point stress as the name suggests is simply stress on the human visual system due to near work, for example, reading. The human visual system, anthropologically speaking, was designed for distance work; namely, hunting and gathering. The industrial revolution represented a turning point in human development, wherein individuals shifted from distance work to near vision work and our anatomy has not yet fully adapted to this change. Essentially, near work does not allow our eyes to relax and ultimately this strain may cause myopia and/or accelerate myopia progression, especially in children and young adults.

The use of digital or electronic devices, for example, tablets and electronic readers world-wide has significantly increased over the last decade. The use of laptops, tablets, electronic readers, phones as well as other hand-held electronic and desktop devices with two-dimensional displays has affected the lives of adults and more significantly the lives of children and young adults given that it permeates almost every aspect of their lives, for example, recreational uses through gaming and social media and educational activities such as reading. Since it is apparent that these devices are now the norm rather than the exception, they should be utilized in the proper manner; namely, by using them at the proper or safe viewing distance to avoid and/or to minimize near-point eye stress. The generally accepted or proper reading or viewing distance is between fourteen (14) and sixteen (16) inches from the eyes to avoid near-point stress. Accordingly, the present invention is directed to a system that may be incorporated into any electronic hand-held or desk top device that includes a two-dimensional display, that distorts the display in some manner when the device is held to closely to the user's eyes and restores the image when the device or user is at the proper viewing distance. In other words, as long as the device is held at the proper distance from the user's eyes, the image is clearly viewable, and when the device is too close, the image is distorted thereby forcing or prompting the user to adjust the distance. The image on the display may be distorted in any number of suitable ways. A suitable way includes any means that renders the image or text unintelligible or unrecognizable but does not in any way have a deleterious effect on the eyes of a user. It is important that the level of distortion is such that no individual, no matter what they do at their current viewing distance or closer renders the image viewable. For example, the image may be blurred or pixelated in some manner. Pixilation is preferred for the reasons set forth subsequently. The means for distorting an image is well known in the electronic display art. In an alternative exemplary embodiment, the display may simply be turned off when the device is too close to the user's eyes and turned back on when the device is at the proper viewing distance for that individual. In this exemplary embodiment, there will be no doubt as to the fact that the device or user should move. The device would automatically turn on and off without any action by the user other than maintaining a proper viewing distance.

In order to determine if the electronic device is at the proper or safe viewing distance for a particular user, the system preferably has a means for determining the distance between the eyes of the user and the display of the electronic device. Many currently available hand-held and desktop electronic devices have built in range finders, for example, infra-red range finders. Stand-alone digital cameras and/or digital cameras that are integrated into other devices such as phones have range finders to accurately determine the distance to a target for autofocusing purposes. Proper viewing distance is the key to eye health and there are many technologies available to determine the distance between a device and a user; however, in order to reduce errors in distance calculations due to the size of the individual, for example, child or adult, and/or the angle or orientation of the display relative to that of the eyes of the user, facial mapping or facial recognition systems may preferably be utilized so that the precise distance between a user's eyes and the display may be calculated rather than the distance between some portion of the user's anatomy and the display. Although different facial mapping or recognition strategies may be utilized in accordance with the present invention, one simple approach may be to identify the user's eyes, determine the position between the eyes, interocular distance, and to average the distance between each of the eyes and the display of the electronic device as is discussed in greater detail subsequently.

Facial recognition technology is part of the field of biometrics which is concerned with the measurement of biological data by a combination of hardware and software. Facial recognition technology uses software to identify or verify a person by mapping facial features, characteristics and dimensions, and comparing the collected information with information stored in a database of faces. Facial recognition systems use a number of measurements and technologies to scan faces, including thermal imaging, three-dimensional face mapping, cataloging unique features; namely, landmarks, analyzing geometric proportions of facial features, mapping the distance between key facial features and skin surface texture analysis. Facial mapping and facial recognition technologies are widely utilized in everything from governmental and commercial security systems to personal electronic devices and may be readily adapted for the purpose of the present invention.

By applying facial mapping/recognition technology and combining it with sensors for determining distance, it is possible to manage and monitor a precise safe distance from the eyes of a user to the display or screen of the electronic device. It is important to note there are numerous ways to accurately determine safe or optimal viewing distances in addition to facial mapping/recognition and they are described herein as exemplary embodiments. Alternative means include proximity sensors, accelerometers and any other suitable means for measuring distance and angles. When the system detects that the distance from the eyes of the user to the display is too close, a signal is automatically sent to scramble the image in any suitable manner as described above thereby rendering it unusable. As soon as the distance is corrected, a signal is automatically sent to restore the image. The user only has to move and maintain the minimum safe operation distance.

The facial mapping/recognition technology is preferably robust enough to accommodate various contingencies. For example, the facial mapping/recognition technology should contain a combination of hardware and software to determine interocular distance through glasses and /or tinted glasses. Simple filtering techniques, whether implemented in hardware, software or a combination thereof may be utilized to accomplish this. In addition, the facial mapping/recognition technology should preferably be able to make the necessary measurements even if the user's face is partially obscured, for example, if the user's mouth and nose are covered. It would also be preferable if the display were not distorted or shut off if the user simple passes his or her hand in front of their face while using the device. In other words, the combination of the facial mapping/recognition technology and the range finder technology should preferably be robust enough to avoid “false alarms.” Once again, it should be noted that there are many alternatives for implementing this feature.

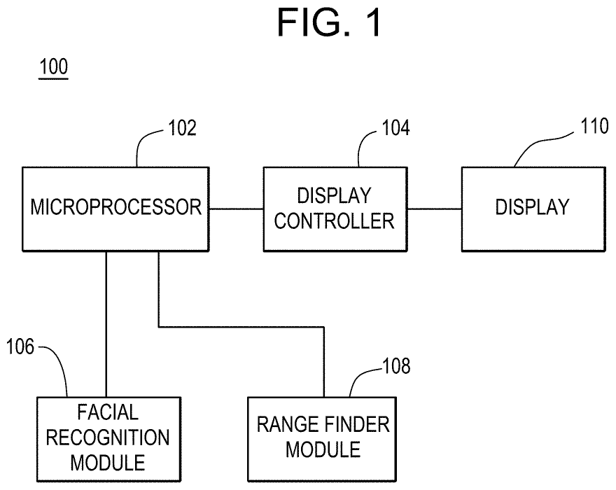

Referring to FIG. 1, there is illustrated a high-level block diagram representation of an exemplary system 100 for reducing the impact of near distance viewing on myopia onset and/or myopia progression. The system 100 comprises a microprocessor 102, a display controller 104, a facial recognition module 106 and a range finder module 108. It is important to note that the microprocessor 102, the display controller 104, the facial recognition module 106 and the range finder module 108 may already be integral with the electronic device as is the display 110, and the software and/or hardware updated to implement the functions of the system 100 in accordance with the present invention. In alternative embodiments, each of these elements and/or software packages may be added to the electronic device to provide the desired functionality. In an alternative exemplary embodiment, the addition of a timer may be utilized to monitor the total duration of viewing, and if a pre-established value/duration is exceeded, the image may be pixelated or otherwise distorted to limit viewing time alone or in combination with monitoring proper viewing distance. This timed usage function may also provide a warning through a pixelated flash or audible alert. The warning, which may be set to a specific duration, may be utilized to alter the user or a user's parents if the user is below a certain age, that the display will be distorted or otherwise shut off for a certain period of time in order for the user to relax his or her eyes. This would be a voluntary function that can be programmed into the system. Even though a user may be utilizing the device at the proper viewing distance, continued near work may also have a deleterious effect regarding myopia onset and progression. This warning will allow the user to take a break from the near work and allow them to participate in distance vision work or play, or simply go outside and be exposed to natural light. The timer function may be implemented in a variety of ways, including those known to those skilled in the art. For example, once the device is turned on and being operated in its intended fashion, the internal processor may run a timing subroutine that generates the alarm at the desired or preprogrammed time. The facial mapping/recognition software may be utilized to determine if the user is a child or an adult as explained in greater detail subsequently. Alternative, the user's age may be preprogrammed into the device as part of the initial setup.

The microprocessor 102 controls the overall function of the system 100. The facial recognition module 106 and the range finder module 108 under the control of the microprocessor 102 periodically, albeit with a high frequency, sends out signals to determine if the user of the electronic device is positioned at the right or optimal distance to view the display on the electronic device. If the electronic device is too close to the user, the microprocessor 102 is notified by signals from the facial recognition module 106 and the range finder module 108 and in response thereto outputs a signal to the display controller 104 to pixelate or otherwise distort the displayed image. As set forth above, some level of pixilation is the preferred manner in which to distort the image. A pixelated image provides a dramatic and clear indication that the device is too close to the user, whereas a blurry image may not be detected by a user, or possibly not noticed by the user, depending on the visual acuity of the user. Once again, pixilation is one exemplary method for distorting the image. Any suitable means may be utilized so long as the image or text is not readable and does no harm by viewing. This has the effect to prompt the user to either move the device back to a safer distance or move him or herself to a safer distance until the position of the device is fixed. Once the optimal or safe viewing distance is reestablished, the facial recognition module 106 and the range finder module 108 will send out a signal to the microprocessor 102 to have the display controller 104 return the image to a sharp and normal presentation mode on the display 110. As long as the optimal or safe distance is maintained, no action is taken by the system 100. In instances where the user is viewing dynamic images such as a video, the video may be paused, pixelated or otherwise distorted simultaneously if the signal is sent indicating the electronic device is too close to the user. Once the position of the device is corrected, the video/image will be restored.

It is important to note that all of the components comprising the system may be implemented in hardware, software and/or a combination of hardware and software. For example, the range finder module 108 may comprise a combination of hardware, e.g. infra-red and/or ultrasonic transducer emitter/detector pairs, and software to control its operation in combination with the display controller 104 and the microprocessor 102. The software may comprise algorithms to simply may distance calculations to object. The facial recognition module 106 may comprise hardware, e.g. a camera or CCD array, and software to control its operation in combination with the display controller 104 and the microprocessor 102. In an exemplary embodiment, the software may include algorithms for calculating the distance between facial features and comparing fascial features to a known set of parameters. The display controller 104 may also comprise a combination of hardware and software to implement its functionality.

In accordance with another exemplary embodiment, the system may include the required hardware, software and/or a combination thereof to allow a user to highlight, zoom in or out, and/or to move text or images around on the display so that the user does not have to adjust his or her distance from the display. Simple touch screen technology that is currently available may be incorporated into the system.

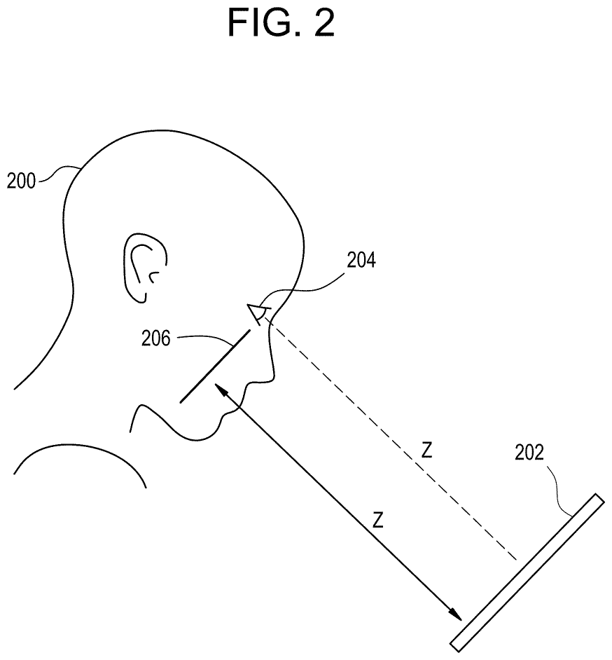

FIG. 2 is a diagrammatic representation of a user 200 viewing a display on an electronic device 202. As illustrated, the combination of the of the facial recognition module 106 and the range finder module 108 locate and determine the distance from the eyes 204 of the user 200 to the electronic device 202. Given that both facial recognition and range finding are utilized, it is possible to form a plane across the user 200 such that the distance, Z, for the user's eyes 204 is always maintained regardless or the orientation of the electronic device and/or the user's head.

As set forth above, myopia onset and/or progression may be affected by viewing habits. The present invention comprises a content display system that utilizes the existing display and electronics, camera/rangefinder, for electronic devices such as tablets, phones and laptops, and based upon viewing distance adjusts the image such that when the display is too close to the viewer, the content, for example, text, video and/or audio is distorted and when the viewing distance is at the proper or safe amount, the content is restored. In one exemplary embodiment, the system utilizes Headtrackr. Headtrackr is a java script library for real-time face tracking and head tracking, tracking the position of a user's head in relation to a device, such as a computer screen, via a web camera and the WebRTX/getUserMedia standard. Once again, Headtrackr is only an exemplary package that may be utilized in accordance with the present invention. Any suitable software package that performs a similar function may be utilized.

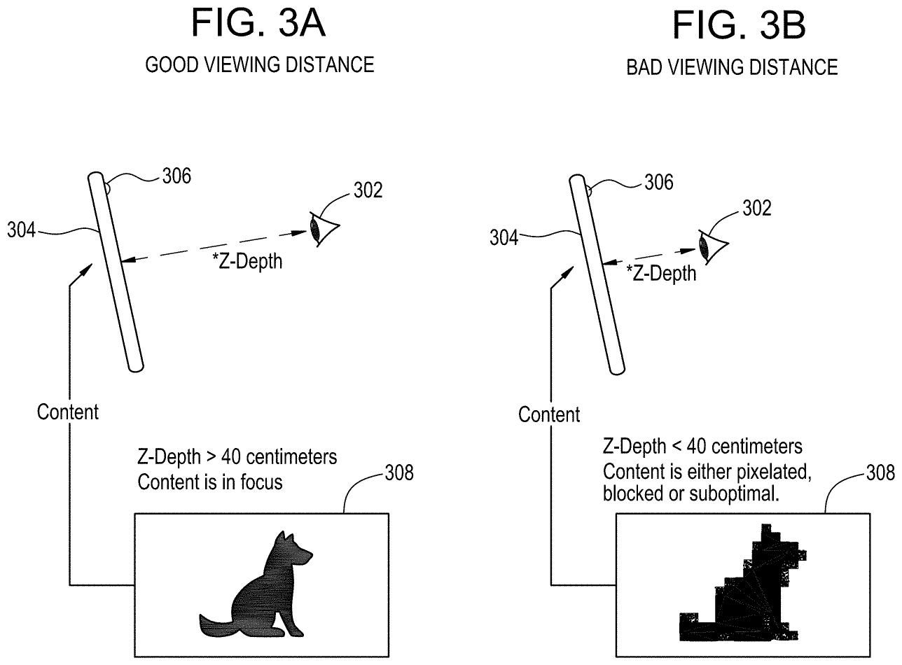

The operation of Headtrackr may be more easily understood by reference to FIGS. 3A and 3B. Utilizing HeadTrackr, the distance Z from a user's eye 302 to a display screen 304 of an electronic device having a camera or distance sensor 306. Based on the data point, Z, the system of the present invention is able to make contextual changes to the content as discussed herein. As may be easily seen, if the user's eye 302 is greater than 40 cm (between 14 and 16 inches) from the device 304, the image 308 is clear. If on the other hand the user's eye 302 is less than 40 cm from the device 304, the image is distorted.

In accordance with one exemplary embodiment, the measured value may be mapped onto a CSS filter, well known in the art. The CSS filter can provide visual effects such as blur or color shifting to render an image sub-optimal. A threshold value for the distance Z may be established such that when the display is too close, the system will swap out the high-resolution text or video to a low or pixelated display/resolution, then return to normal when the device is above the threshold distance. The same system may be utilized for sound using the same concepts set forth herein. In addition, as set forth above, additional coordinates or dimensions X and Y may be obtained to determine the user's exact position relative to the device as is explained in greater detail below.

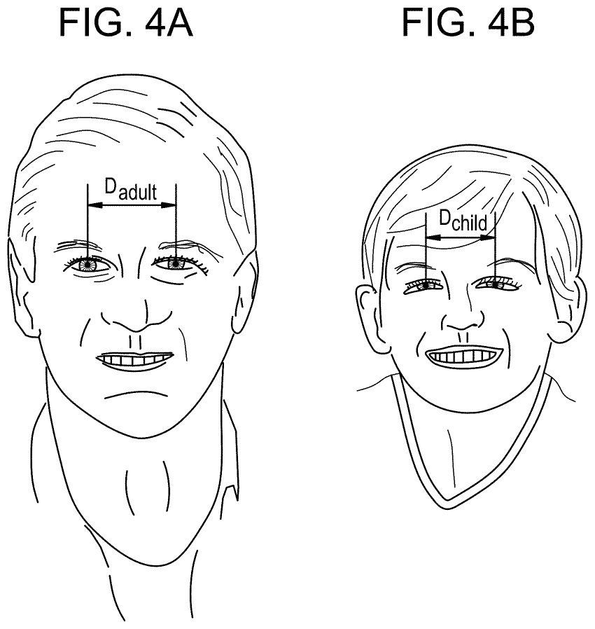

FIGS. 4A and 4B are diagrammatic representations of an adult's face and a child's face respectively mapped in accordance with the present invention. The two faces are side-by-side to highlight the dimensional/distance mapping differences of an adult's face topography relative to a child's face topology. Differences in age may be accounted for by the system of the present invention to adjust the proper viewing distance as well as the proper viewing time. Essentially, the average pupillary distance for an adult is between 54 and 68 mm with acceptable measurement deviations generally falling between 48 and 73 mm, whereas for a child the pupillary distance is between 41 and 55 mm. Other features may be utilized in accordance with the present invention, however, pupillary distance is easily measured. D_{adult} and D_{child} show the respective pupillary distances respectively.

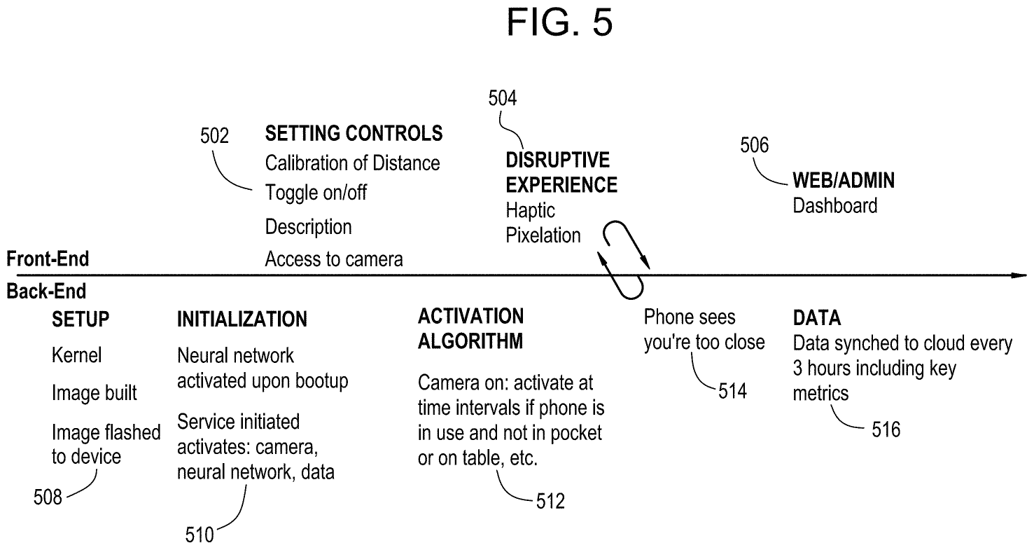

In accordance with another exemplary embodiment, the present invention is directed to a system that is installed via an application that adds an accessibility feature to the native setting application of the operating system of the mobile device. This system may be added to any mobile device as described herein; however, for ease of explanation it is described below with respect to a mobile phone, for example, all versions of Android phones from API 23 forward. Mobile phones are the most popular form of mobile device. In addition, this may be utilized on non-mobile devices such as desktop devices. The system or application is designed to enhance the functionality associated with the disruption of a mobile user's experience when their viewing distance becomes unsafe as set forth above. The application comprises two main features; namely, calibration and disruption event settings. Details of these settings are described in detail below and with respect to FIG. 5 which illustrates the settings as front-end and back-end functionality. The majority of the functionality will exist in the accessibility feature that runs the service throughout any usage of the operating system. In other words, the user may control and/or feature, function or application of the phone normally while this application is running.

The calibration process involves asking the user to take a front facing image of their face at a distance of twelve (12) inches from the camera lens. This distance may be measured in any number of ways, including simple devices such as rulers, or even a measured piece of string. Other elaborate devices may be utilized as well. Utilizing the ML Kit for Firebase, the contours of the user's face, captured as described above, are recorded in memory. ML Kit comes with a set of ready-to-use APIs for mobile devices that recognize text, detect faces, identify landmarks, scan bar codes, label images and the like. With ML Kit, the center of each eye of the user is identified to calculate the total pixel distance from eye to eye. Utilizing the camera metadata on the device, this pixel distance is multiplied by the camera sensor width and divided by the camera resolution width to obtain the eye width on camera sensor. The eye width on camera sensor is then multiplied by the required twelve (12) inch picture capturing distance and divided by the focal length of the camera to yield the exact distance between the user's eyes or inter-pupillary distance in inched. This calculated vale is saved to device memory to be utilized later by the accessibility service. It is important to note this calibration step is optional and may be skipped. As calibration is optional, the value for inter-pupillary distance will be set to two and one-half (2.5) inches if the user chooses or selects not to perform the calibration. The implication of an incorrect inter-pupillary distance may be an incorrect disruption distance when the service is running. More specifically, if no calibration is done, disruption may occur either when the mobile device is too close or too far for that specific individual.

In this exemplary embodiment, there are two different disruption events that the user of the device may choose from. One disruption event is an overlay or dimming of the image as to make it unusable. The second disruption even is haptic feedback or vibration. The user may select either disruption event, both of the disruption events or neither event for a total of four (4) possible experiences while the service is running. It is important to note that users may find one of the possible sections to be more effective than the others. In addition, this is only an exemplary embodiment and other possible disruption events are within the scope of the invention, including audio alarms or cues, such as visual cues, including animation.

When the user turns on or actuates the accessibility feature, one of four (4) possible phases of operation will be entered. The least obtrusive phase causes the service to sleep. This first phase occurs if the user locks their mobile device, phone, or turns the screen off. The service will be triggered to wake-up when the device is back in use. In this second phase, the service will tick every two seconds. Each tick takes a forward-facing picture to determine if a face is present. As described above, this face identifying operation is performed utilizing the ML Kit for Firebase. If no face is detected or present, the service will continue to tick at this two second rate until a face is detected. Once again, this two second rate is exemplary and other rates fall within the scope of the invention. In other words, different time intervals may be utilized. If a face is detected or present, the service will enter the next or third phase of operation wherein it will tick every second and measure the distance from the screen of the mobile device to the user's face.

In this exemplary embodiment, distance from camera or screen to face is calculated in a manner that is opposite as to how the distance between the eyes or inter-pupillary is calculated by the service as set forth above. The pixel distance between the eyes is measured and corrected for any rotation in the user's face. Eye width on center is again calculated and sensor width times pixel distance divided by camera resolution width is implemented. However, in this instance, the user's calibrated distance between their eyes is obtained from memory. The default value may also be utilized if no calibration were done. This value, default or from memory is multiplied by the focal length of the camera of the mobile device and divided by the eye width on sensor to yield the number of inches between the user's face and the screen on the mobile device.

If this calculated distance is greater than the established safe distance of fifteen (15) inches, the service will continue in this phase. If it is determined that the user's face is less than the fifteen (15) inches away from the device, the service will enter the final or fourth phase where it continues at the same rate but disrupts the user in some manner as described above, for example, overlay/dimming or haptic. Essentially, whichever settings were selected by the user in the application, haptic or dimming, that setting will be applied to the mobile device screen. It is important to note that both settings are on by default and if the user does not specify, the screen will be dimmed, and a vibration will be applied. This phase will continue until the user moves their face or moves the device to a safe distance between the face and device.

If the user were to maintain this service on for an extended period of time, it is believed that this would create a negative reinforcement environment that would eventually build a habit for the user to keep their face away from being too close to the screen of the mobile device, even when the service is not running. If users are trained to use their mobile device, phone, as a safe distance from the screen, scientific evidence suggests that the likelihood that myopia progression may be reduced in the long run for the reasons set forth herein.

Referring now to FIG. 5, there is illustrated a high-level minimal viable product flow diagram illustrating the front-end and back-end processes of the application or service. On the front-end there is the setting of controls 502, the disruptive experience 504 and internet and administration functions 506. The setting of controls 502 includes the on/off operation, a description of the process, access to the camera of the mobile device, and calibration of distance. The disruptive experience 504 includes the haptic, pixilation, overlay, dimming or any of the disruptive experiences described herein. The internet and administrations functions 506 includes data collection/dashboarding. On the back-end, there is setup 508, initialization 510, activation algorithm 512, distance determination 514 and data 516. In setup 508, the kernel, image build and image flashed to the mobile device is handled. In initialization 510, the neural network for the recognition aspects described above are activated upon bootup of the mobile device and service is initiated, including camera and the neural network. The activation algorithm 512 includes turning on the camera of the device and setting the time intervals set forth above. In distance determination 514, if the mobile device is too close to the users face, the disruptive experience 504 is implemented. In the data function 516, data is synchronized to the cloud every three (3) hours. Different intervals may be utilized.

Although shown and described is what is believed to be the most practical and preferred embodiments, it is apparent that departures from specific designs and methods described and shown will suggest themselves to those skilled in the art and may be used without departing from the spirit and scope of the invention. The present invention is not restricted to the particular constructions described and illustrated but should be constructed to cohere with all modifications that may fall within the scope of the appended claims.

What is claimed is:

1. A system for reducing the impact of near distance viewing on at least one of myopia onset and myopia progression, the system comprising:
an electronic display;
a range finder operatively associated with the electronic display and configured to determine the distance between a user and the electronic display;
a display controller operatively associated with the electronic display; and
a microprocessor in communication with and configured to coordinate the operation of the range finder and the display controller, wherein the microprocessor is configured to automatically disrupt the display via the display controller when the display is too close to the user and automatically restoring the image when the display is at a proper viewing distance, the microprocessor including an application having calibration and disruption event functionality to determine interpupillary distance and distance from the user to the display, wherein if the display is less than fifteen inches from the user then the display is disrupted and if the display is greater than fifteen inches from the user then the image is not disrupted.

2. The system for reducing the impact of near viewing on at least one myopia onset and myopia progression according to claim 1, wherein the electronic display is part of an electronic device.

3. The system for reducing the impact of near viewing on at least one myopia onset and myopia progression according to claim 2, wherein the electronic device is a hand-held device.

4. The system for reducing the impact of near viewing on at least one myopia onset and myopia progression according to claim 2, wherein the electronic device is a desk-top device.

5. A method for reducing the impact of near distance viewing on at least one of myopia onset and myopia progression, the method comprising the steps of:
implementing an application on a device, the application calculating the interpupillary distance between a user's eyes and the distance between a user and an electronic display, the application continuously running while the device is on;
automatically disrupting an image displayed on the electronic display when the calculated distance between a user and the electronic display is below a predetermined threshold; and
automatically restoring the image displayed on the electronic display when the calculated distance between a user and the electronic display is at or above the predetermined threshold.
